(19) United States
(12) Patent Application Publication
(10) Pub. No.: US 2012/0138026 A1
(43) Pub. Date: Jun. 7, 2012

(54) METHOD OF DIAGNOSING A LOW BOOST IN A DIESEL ENGINE

(75) Inventor: Christoph Niessen, Clinton Twp., MI (US)

(73) Assignee: Detroit Diesel Corporation, Detroit, MI (US)

(21) Appl. No.: 12/961,968

(22) Filed: Dec. 7, 2010

(51) Int. Cl. F02B 33/00

(52) U.S. Cl. 123/564

(57) ABSTRACT

A method to operate an electronically controlled internal combustion engine to diagnose low boost. In one embodiment, the method may include determining whether changes in at least one engine operating condition has occurred; comparing actual engine boost signal with a predetermined boost signal; maintaining engine operating conditions for a predetermined period of time to ensure stability of boost signal gradient for a first predetermined period of time; determining whether boost signal gradient is stable for a second predetermined period of time; determining boost signal change by comparing stability of actual boost signal with a predetermined boost signal determining whether boost signal is stable; and ceasing boost signal monitoring prior to active boost signal gradient change.

### TECHNICAL FIELD

On highway vehicles powered by heavy duty diesel engines are subject a variety of on board diagnostic requirements from various governmental agencies, including the California Air Resource Board Heavy Duty On Board Diagnostic regulation “Title 13, California Code Regulations, Section 1971.1 On-Board Diagnostic System Requirements for 2010 and Subsequent Model Year Heavy Duty Engines (HD OBD)”, Euro IV, V and eventual Euro VI requirements. The United States Environmental Protection Agency is also expected to adopt similar requirements for on board diagnostics. As stated in the California Air Resource Board HDOBD regulation, “The purpose of the California Air Resource Board HDOBD regulation is to establish emission standard and other requirements for onboard diagnostics systems (OBD systems) that re installed on 2010 and subsequent model year engines certified for sale in heavy duty applications in California. The OBD systems, through the use of an onboard computer(s) shall monitor emissions systems in use for the actual life of the engine and shall be capable of detecting malfunctions of the monitored emission systems, illuminating a malfunction indicator light (MIL) to notify the vehicle operator of detected malfunctions, and storing fault codes identifying the detected malfunctions.

These regulations require a method of monitoring all of the various systems that impact emissions to verify their functionality. Additionally, diagnosis is also required at the component level.

### BRIEF SUMMARY

In one aspect, the present invention is directed to a method to operate an electronically controlled internal combustion engine to diagnose low boost. The method may comprise determining whether changes in at least one engine operating condition have occurred; comparing actual engine boost signal with a predetermined boost signal; maintaining engine operating conditions for a predetermined period of time to ensure stability of boost signal gradient for a first predetermined period of time; determining whether boost signal gradient is stable for a second predetermined period of time; determining boost signal change by comparing stability of actual boost signal with a predetermined boost signal; determining whether boost signal is stable; and ceasing boost signal monitoring prior to active boost signal gradient change.

In another aspect, the method boost signal changes occur in response to change in at least one of engine speed, (RPM) engine torque (ETQ) EGR or intake throttle. At least one of EGR, ETQ or ETQ may be monitored for a predetermined period of time to determine boost signal stability.

### BRIEF DESCRIPTION OF THE DRAWINGS

FIG. 1 is a schematic representation of an internal combustion engine;

FIG. 2 is a graphic representation of a monitoring condition when to measure boost according to one non limiting aspect of the present invention;

FIG. 3 is a schematic representation of one non limiting method to diagnose low boost according to the present invention.

### DETAILED DESCRIPTION

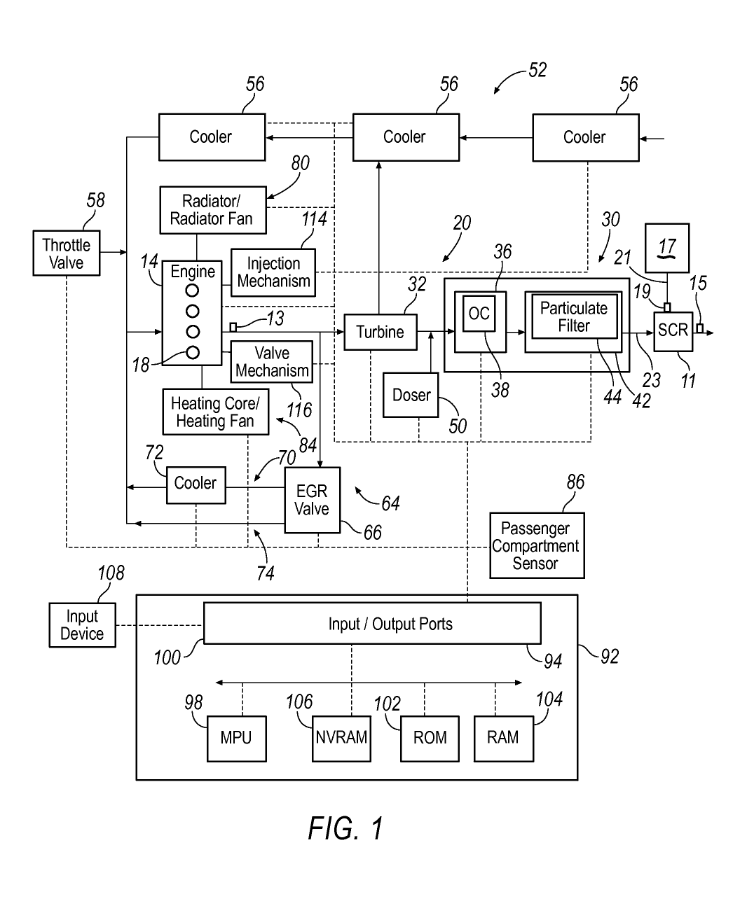

FIG. 1 illustrates a vehicle powertrain system 10 in accordance with one non-limiting aspect of the present invention. The system 10 may provide power for driving any number of vehicles, including on-highway trucks, construction equipment, marine vessels, stationary generators, automobiles, trucks, tractor-trailers, boats, recreational vehicle, light and heavy-duty work vehicles, and the like.

The system 10 may be referred to as an internal combustion driven system wherein fuels, such as gasoline and diesel fuels, are burned in a combustion process to provide power, such as with a spark or compression ignition engine 14. The engine 14 may be a diesel engine that includes a number of cylinders 18 into which fuel and air are injected for ignition as one skilled in the art will appreciate. The engine 14 may be a multi-cylinder compression ignition internal combustion engine, such as a 4, 6, 8, 12, 16, or 24 cylinder diesel engines, for example. It should be noted, however, that the present invention is not limited to a particular type of engine or fuel.

Exhaust gases generated by the engine 14 during combustion may be emitted through an exhaust system 20. The exhaust system 20 may include any number of features, including an exhaust manifold and passageways to deliver the emitted exhaust gases to a particulate filter assembly 30, which in the case of diesel engines is commonly referred to as a diesel particulate filter. Optionally, the system 20 may include a turbocharger proximate the exhaust manifold for compressing fresh air delivery into the engine 14. The turbocharger, for example, may include a turbine 32 and a compressor 34, such as a variable geometry turbocharger (VGT) and/or a turbo compound power turbine. Of course, the present invention is not limited to exhaust systems having turbochargers or the like.

The particulate filter assembly 30 may be configured to capture particulates associated with the combustion process. In more detail, the particulate filter assembly 30 may include an oxidation catalyst (OC) canister 36, which in includes an OC 38, and a particulate filter canister 42, which includes a particulate filter 44. The canisters 36, 42 may be separate components joined together with a clamp or other feature such that the canisters 36, 42 may be separated for servicing and other operations. Of course, the present invention is not intended to be limited to this exemplary configuration for the particulate filter assembly 30. Rather, the present invention contemplates the particulate filter assembly including more or less of these components and features. In particular, the present invention contemplates the particulate filter assembly 30 including only the particulate filter 44 and not necessarily the OC canister 36 or substrate 38 and that the particulate filter 44 may be located in other portions of the exhaust system 20, such as upstream of the turbine 32.

The OC 38, which for diesel engines is commonly referred to as a diesel oxidation catalyst, may oxidize hydrocarbons and carbon monoxide included within the exhaust gases so as to increase temperatures at the particulate filter 44. The particulate filter 44 may capture particulates included within the exhaust gases, such as carbon, oil particles, ash, and the like, and regenerate the captured particulates if temperatures associated therewith are sufficiently high. In accordance with one non-limiting aspect of the present invention, one object of the particulate filter assembly 30 is to capture harmful carbonaceous particles included in the exhaust gases and to store these contaminates until temperatures at the particulate filter 44 favor oxidation of the captured particulates into a gas that can be discharged to the atmosphere.

The OC and particulate filter canisters 36, 42 may include inlets and outlets having defined cross-sectional areas with expansive portions there between to store the OC 38 and particulate filter 44, respectively. However, the present invention contemplates that the canisters 36, 42 and devices therein may include any number configurations and arrangements for oxidizing emissions and capturing particulates. As such, the present invention is not intended to be limited to any particular configuration for the particulate filter assembly 30.

To facilitate oxidizing the capture particulates, a doser 50 may be included to introduce fuel to the exhaust gases such that the fuel reacts with the OC 38 and combusts to increase temperatures at the particulate filter 44, such as to facilitate regeneration. For example, one non-limiting aspect of the present invention contemplates controlling the amount of fuel injected from the doser as a function of temperatures at the particulate filter 44 and other system parameters, such as air mass flow, EGR temperatures, and the like, so as to control regeneration. However, the present invention also contemplates that fuel may be included within the exhaust gases through other measures, such as by controlling the engine 14 to emit fuel with the exhaust gases.

The exhaust system may also include a Selective Catalyst Reducer (SCR) 11 to introduce a reductant, such as urea or ammonia, either hydrous or anhydrous, to a catalyst bed in the SCR to reduce NOx levels in the exhaust flow stream 23. Generally, the engine may include a NOx engine out sensor 13 and a NOx tail pipe out sensor 15 that are in electronic communication with the electronic controller and transmit data signal indicative of the level of NOx gas in the exhaust. The reductant is stored in a receptacle, such as tank 17, and is introduced into the SCR by at least one reductant injector 19. The reductant injector is in fluid communication 21 with the reductant tank and introduces reductant to the SCR when the received NOx sensor data is indicative of excess NOx levels in the exhaust gas stream.

An air intake system 52 may be included for delivering fresh air from a fresh air inlet 54 through an air passage to an intake manifold for introduction to the engine 14. In addition, the system 52 may include an air cooler or charge air cooler 56 to cool the fresh air after it is compressed by the compressor 34. Optionally, a throttle intake valve 58 may be provided to control the flow of fresh air to the engine 14. Optionally, the throttle intake valve 58 may also be provided to control the flow of EGR gases to the engine 14 or control both fresh air and EGR gases 64 to the engine 14. The throttle valve 58 may be a manually or electrically operated valve, such as one which is responsive to a pedal position of a throttle pedal operated by a driver of the vehicle. There are many variations possible for such an air intake system and the present invention is not intended to be limited to any particular arrangement. Rather, the present invention contemplates any number of features and devices for providing fresh air to the intake manifold and cylinders, including more or less of the foregoing features.

An exhaust gas recirculation (EGR) system 64 may be optionally provided to recycle exhaust gas to the engine 14 for mixture with the fresh air. The EGR system 64 may selectively introduce a metered portion of the exhaust gasses into the engine 14. The EGR system 64, for example, may dilute the incoming air charge and lower peak combustion temperatures to reduce the amount of oxides of nitrogen produced during combustion. The amount of exhaust gas to be recirculated may be controlled by controlling an EGR valve 66 and/or in combination with other features, such as the turbocharger. The EGR valve 66 may be a variable flow valve that is electronically controlled. There are many possible configurations for the controllable EGR valve 66 and embodiments of the present invention are not limited to any particular structure for the EGR valve 66.

The EGR system 64 in one non-limiting aspect of the present invention may include an EGR cooler passage 70, which includes an EGR cooler 72, and an EGR cooler bypass 74. The EGR valve 66 may be provided at the exhaust manifold to meter exhaust gas through one or both of the EGR cooler passage 70 and bypass 74. Of course, the present invention contemplates that the EGR system 64 may include more or less of these features and other features for recycling exhaust gas. Accordingly, the present invention is not intended to be limited to any one EGR system and contemplates the use of other such systems, including more or less of these features, such as an EGR system having only one of the EGR cooler passage or bypass.

A cooling system 80 may be included for cycling the engine 14 by cycling coolant there through. The coolant may be sufficient for fluidly conducting away heat generated by the engine 14, such as through a radiator. The radiator may include a number of fins through which the coolant flows to be cooled by air flow through an engine housing and/or generated by a radiator fan directed thereto as one skilled in the art will appreciated. It is contemplated, however, that the present invention may include more or less of these features in the cooling system 80 and the present invention is not intended to be limited to the exemplary cooling system described above.

The cooling system 80 may operate in conjunction with a heating system 84. The heating system 84 may include a heating core, a heating fan, and a heater valve. The heating core may receive heated coolant fluid from the engine 14 through the heater valve so that the heating fan, which may be electrically controllable by occupants in a passenger area or cab of a vehicle, may blow air warmed by the heating core to the passengers. For example, the heating fan may be controllable at various speeds to control an amount of warmed air blown past the heating core whereby the warmed air may then be distributed through a venting system to the occupants. Optionally, sensors and switches 86 may be included in the passenger area to control the heating demands of the occupants. The switches and sensors may include dial or digital switches for requesting heating and sensors for determining whether the requested heating demand was met. The present invention contemplates that more or less of these features may be included in the heating system and is not intended to be limited to the exemplary heating system described above.

A controller 92, such as an electronic control module or engine control module, may be included in the system 10 to control various operations of the engine 14 and other system or subsystems associated therewith, such as the sensors in the exhaust, EGR, and intake systems. Various sensors may be in electrical communication with the controller via input/output ports 94. The controller 92 may include a microprocessor unit (MPU) 98 in communication with various computer readable storage media via a data and control bus 100. The computer readable storage media may include any of a number of known devices which function as read only memory 102, random access memory 104, and non-volatile random access memory 106. A data, diagnostics, and programming input and output device 108 may also be selectively connected to the controller via a plug to exchange various information therebetween. The device 108 may be used to change values within the computer readable storage media, such as configuration settings, calibration variables, instructions for EGR, intake, and exhaust systems control and others.

The system 10 may include an injection mechanism 114 for controlling fuel and/or air injection for the cylinders 18. The injection mechanism 114 may be controlled by the controller 92 or other controller and comprise any number of features, including features for injecting fuel and/or air into a common-rail cylinder intake and a unit that injects fuel and/or air into each cylinder individually. For example, the injection mechanism 114 may separately and independently control the fuel and/or air injected into each cylinder such that each cylinder may be separately and independently controlled to receive varying amounts of fuel and/or air or no fuel and/or air at all. Of course, the present invention contemplates that the injection mechanism 114 may include more or less of these features and is not intended to be limited to the features described above.

The system 10 may include a valve mechanism 116 for controlling valve timing of the cylinders 18, such as to control air flow into and exhaust flow out of the cylinders 18. The valve mechanism 116 may be controlled by the controller 92 or other controller and comprise any number of features, including features for selectively and independently opening and closing cylinder intake and/or exhaust valves. For example, the valve mechanism 116 may independently control the exhaust valve timing of each cylinder such that the exhaust and/or intake valves may be independently opened and closed at controllable intervals, such as with a compression brake. Of course, the present invention contemplates that the valve mechanism may include more or less of these features and is not intended to be limited to the features described above.

In operation, the controller 92 receives signals from various engine/vehicle sensors and executes control logic embedded in hardware and/or software to control the system 10. The computer readable storage media may, for example, include instructions stored thereon that are executable by the controller 92 to perform methods of controlling all features and sub-systems in the system 10. The program instructions may be executed by the controller in the MPU 98 to control the various systems and subsystems of the engine and/or vehicle through the input/output ports 94. In general, the dashed lines shown in FIG. 1 illustrate the optional sensing and control communication between the controller and the various components in the powertrain system. Furthermore, it is appreciated that any number of sensors and features may be associated with each feature in the system for monitoring and controlling the operation thereof

In one non-limiting aspect of the present invention, the controller 92 may be the DDEC controller available from Detroit Diesel Corporation, Detroit, Mich. Various other features of this controller are described in detail in a number of U.S. patents assigned to Detroit Diesel Corporation. Further, the controller may include any of a number of programming and processing techniques or strategies to control any feature in the system 10. Moreover, the present invention contemplates that the system may include more than one controller, such as separate controllers for controlling system or sub-systems, including an exhaust system controller to control exhaust gas temperatures, mass flow rates, and other features associated therewith. In addition, these controllers may include other controllers besides the DDEC controller described above.

In accordance with one non-limiting aspect of the present invention, the controller 92 or other feature may be configured for permanently storing emission related fault codes in memory that is not accessible to unauthorized service tools. Authorized service tools may be given access by a password and in the event access is given, a log is made of the event as well as whether any changes that are attempted to made to the stored fault codes. It is contemplated that any number of faults may be stored in permanent memory, and that preferably eight such faults are stored in memory.

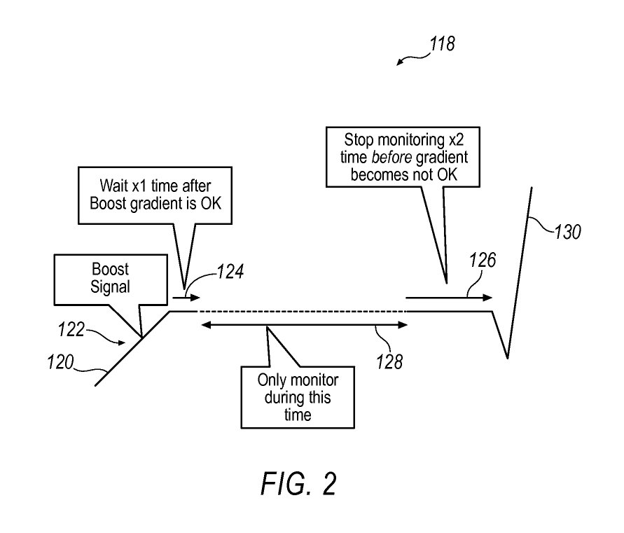

Turning now to FIG. 2, there is illustrated therein one condition 118 that may be monitored to determine when to measure boost signal 120 according to one non limiting aspect of the present invention. Basically, low boost may be summarized as the condition when the actual boost is lower than the expected boost. Boost is highly sensitive to changes in the engine speed/engine load, EGR rate, and intake throttle valve. Thus, it is necessary to monitor boost when the gradient 122, defined as change of signal vs. time, of the boost signal 120 is stable. If the gradient of the boost signal is stable for a time 1X, depicted at 124, and it is predicted that it will remain stable for a time period 2X, depicted at 126, the actual and compared boost signal are compared during the time 128. It is understood that the expected boost is a function of engine speed (RPM) engine load, EGR and intake throttle valve. If the actual boost is lower than the expected boost, it is an indication of a problem of the engine to meet the boost, and a fault is returned by the engine controller. An alert may be indicated on board of a vehicle. It is appreciated that the filters shown in FIG. 2 are first order filters shown at 124 and 126 that eliminate any high frequency signal noise effects on the robustness of the algorithm. Monitoring of the boost signal ceases before the gradient becomes unstable, as depicted at 130.

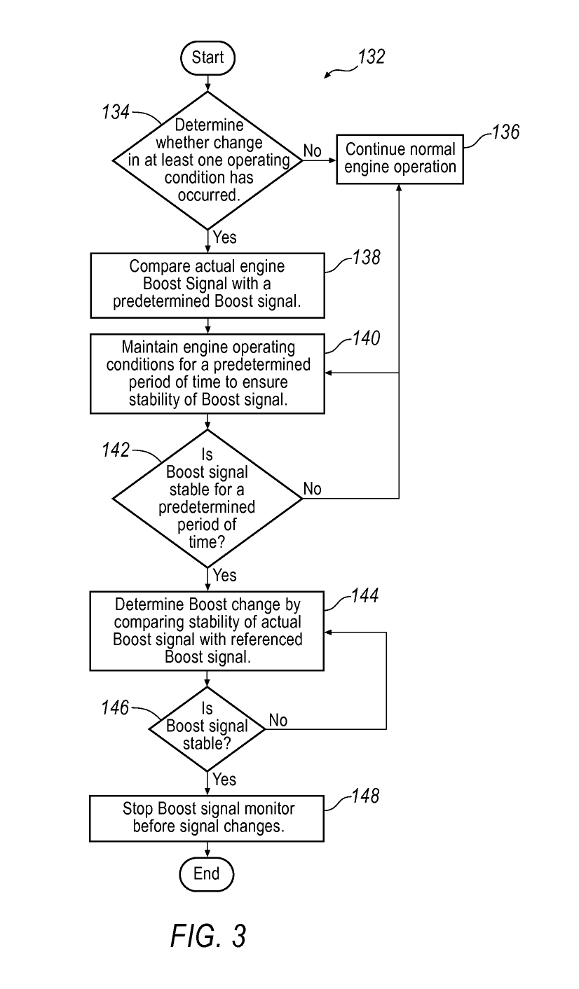

FIG. 3 is a schematic representation of one non limiting method 132 to diagnose low boost according to one aspect of the present invention.

Specifically, step 134 is determining whether changes in at least one engine operating condition has occurred. The engine operating condition may include engine speed, engine load, EGR rate, and intake throttle valve position. If no such change has occurred, the method proceeds to step 136, and normal engine operation is continued.

If a change in an engine operating condition has occurred, step 138 is comparing the actual boost signal with a predetermined boost signal while maintaining the engine operating conditions for a predetermined period of time to ensure stability of the boost signal. Step 140 is determining whether the gradient of the boost signal is stable for a first predetermined period of time. If not, the method loops back to step 138. If the gradient of the boost signal is stable for a first predetermined period of time, and will stay stable for a second predetermined period of time, step 142 is determining boost signal change by comparing stability of the actual boost signal with a referenced boost signal. If it is determined that the boost signal is not stable, a fault is indicated and an alert may be given, such as a warning light, as indicated at step 144. If the gradient of the boost signal is stable at 146, step 148 is ceasing monitoring boost signal before boost the boost signal changes. If the boost signal is not stable, the method loops back to step 144.

It is understood that the words used in the description of the non limiting embodiments are words of description, and not words of limitation. Many variations and modifications will be apparent to those skilled in the art without departing form the scope and spirit of the invention as set forth in the appended claims.

What is claimed as new and desired to be protected by Letters Patent of the United States is:

1. A method to operate an electronically controlled internal combustion engine comprising:
a) determining whether changes in at least one engine operating condition has occurred;
b) comparing actual engine boost signal with a predetermined boost signal;
c) maintaining engine operating conditions for a predetermined period of time to ensure stability of boost signal gradient for a first predetermined period of time;
d) determining whether boost signal gradient is stable for a second predetermined period of time;
e) determining boost signal change by comparing stability of actual boost signal with a predetermined boost signal determining whether boost signal is stable; and
f) ceasing boost signal monitoring prior to active boost signal gradient change.

2. The method of claim 1, wherein said boost signal changes occur in response to change in at least one of engine speed, (RPM) engine torque (ETQ) EGR or intake throttle.

3. The method of claim 1, wherein at least one of EGR, ETQ or ETQ are monitored for a predetermined period of time to determine boost signal stability.

4. A controller for on board diagnostics configured to monitor boost signal, comprising;
a) determine whether a change in at lease one engine operation condition has occurred;
b) compare actual engine boost signal with a predetermined boost signal;
c) monitor engine operating conditions for a predetermined period of time to ensure stabilization of boost signal;
d) determine whether boost signal is stable for a predetermined period of time;
e) determine boost signal change by comparing stability of actual boost signal with a predetermined boost signal;
f) determine whether boost signal is stable; and
g) cease boost signal monitoring prior to actual boost signal gradient change.
